(19) United States
(12) Patent Application Publication
(10) Pub. No.: US 2011/0304542 A1
(43) Pub. Date: Dec. 15, 2011

(54) MULTI PURPOSE REMOTE CONTROL WITH DISPLAY

(76) Inventor: Isaac Calderon, San Diego, CA (US)

(21) Appl. No.: 12/813,215

(22) Filed: Jun. 10, 2010

(51) Int. Cl. G08B 5/22; G06F 3/033

(52) U.S. Cl. 345/163; 340/6.1

(57) ABSTRACT

A device for remotely controlling a media device is provided. A related system and method is included. The device includes a body, circuitry and multiple control input mechanisms generating and sending control signals to a media device by wireless communications. The multiple control input mechanisms include a keyboard, mouse, directional pad and various keys for selecting and controlling modes of the remote control device and the appearance and movement of images displayed on the display of the media device. The device further includes its own display for displaying entries to the keyboard of the device concurrently with engaging the keys, such as when a user enters the name of a command, program, address or search string. The display further includes a light sensitive display for illumination of a backlight when the ambient light goes below a certain threshold.

### FIELD OF THE INVENTION

The present invention pertains generally to a remote control device for generating and sending control signals to a media device by wireless communications. More particularly, the invention pertains to using a remote control device for generating control signals from multiple input mechanisms in multiple modes. The present invention is more particularly, but not exclusively, useful as a system for remotely controlling a media device, such as an internet television device, wherein the remote control device includes a keyboard and a display so that the user can key in commands to the remote control device and concurrently see the commands in the display of the remote device.

### BACKGROUND OF THE INVENTION

Various forms of remote controls for media devices, such as televisions, computers and internet televisions are available. These include means for inputting text, such as keyboards, and for directional movement of the position of a cursor on a screen of the media device, such as a mouse and directional pad. Important factors in considering the utility of such remote control devices are the range of inputs and modes available in the devices and the ease of using the device to control media devices. Problems arise where multiple remote control devices are required to provide a range of control signals and to control a range of possible media devices in a common setting. Problems also arise with inputting control signals into remote control devices, particularly text signals via a remote keyboard, without having the ability to display the text as it is input on the device. Otherwise, the user must input text signals to the remote device, and then look elsewhere to the display of the media device to check the text entered. This cycle is often repeated many times in the course of entering relatively simple information, such as a title, which is tedious and confusing.

In light of the above, an object of the present invention is to provide a small, handheld remote control device for generating control signals from multiple input mechanisms based on multiple modes selected by the user of the remote control device. Yet another object of the invention is to provide such a device including a display along with the input mechanisms, such as a keyboard, so that the user can see the commands in the display of the remote device key as text and other commands are input into the remote control device via the keyboard. Yet another object of the invention is to provide the device and a method for using the remote device, including a backlight to illuminate the display and the keyboard in low light conditions. Yet another object of the invention is to provide a system in which to use this device, including various possible media devices, such as internet television systems. Yet another object of the invention is to provide such a device, system and method that is easy to use, simple to install and comparatively cost effective.

### SUMMARY OF THE INVENTION

In accordance with the present invention, a remote control device is provided for controlling a media device. This remote control includes multiple control signal input mechanisms, such as a keyboard, trackball mouse, and directional pad mounted on the body of the device. These input mechanisms are each easily engaged by a user of the device, such as by pressing the keys or moving the mouse, to enter text, symbols and instructions for control signals. To communicate with the media device, the remote control device of the present invention also includes a transmitter to wirelessly communicate with a receiver that is in communication with the media device, whereby the transmitter provides control signals from the remote device to the media device via the receiver.

More specifically, the present invention also includes one control signal input mechanism comprising a keyboard as well as a display mounted on the front side of the body of the device. The keyboard has keys which generate control signals when pressed to represent symbols in multiple modes. The display shows the symbols in response to the engagement of the keys of the keyboard. Preferably, the keyboard comprises a QWERTY style layout keyboard. The combination of the keyboard and display allow a user to concurrently input text and other symbols to the keyboard and see that text displayed on the remote device. As such, the user can look at the keyboard and directly above the keyboard to the display to easily see the text entered, rather than attempting to press keys on the remote device and then look at a display of the separate media device to check the text and other symbols entered.

The device of the present invention further includes a light sensor to detect the light reaching the sensor. For instances where the light is too low, the display further comprises a backlight that is illuminated based on the sensor and circuitry. If the sensor does not detect a certain threshold of light, then the backlight is illuminated and the user can see the display and the keyboard more easily.

The remote control device also includes multiple additional input mechanisms for controlling the display and play of media on media devices, such as controlling the applications, images, menus and screens selected by the media device and displayed by the media device. As such, the remote control provides a multiple purpose controller for media devices, such as internet television and other computer and television systems. The device is small and can be operated with one hand. The remote control device can be used along with the media device to comprise an entertainment system. The invention also includes a method for using the remote control device to control the media device and achieve the user friendly features described above.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a situational view of the remote control device and system of the present invention;

FIG. 2 is a perspective view of the remote control device of the present invention;

FIG. 3 is a side view of the remote control device of the present invention;

FIG. 4 is a back side view of the remote control device of the present invention;

FIG. 5 is a flow chart showing the circuitry of the remote control device of the present invention;

FIG. 6 is a perspective view of the receiver of the present invention; and

FIG. 7 is an exploded perspective view of the remote control device of the present invention.

### DESCRIPTION OF THE PREFERRED EMBODIMENTS

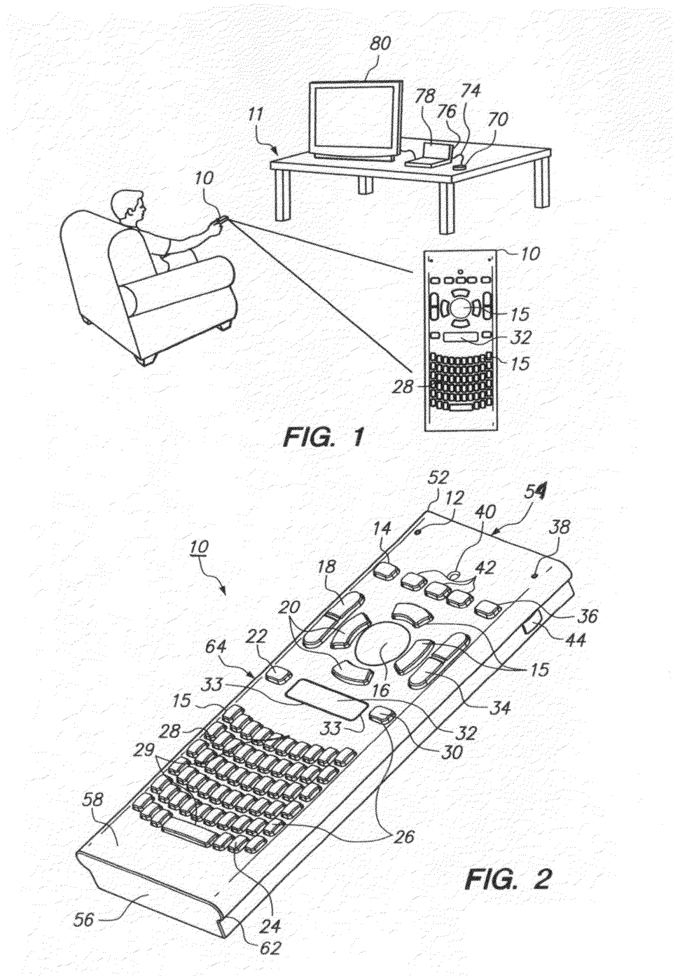

As shown in FIG. 1, system 11 of the present invention includes the remote control device 10 of the present invention to control a media device 76, such as a computer system 78 and/or TV system 80, including an Internet television system. As shown, device 10 is a handheld remote control. General dimensions for device 10 include about 2-3 inches in width, 6-8 inches in length and 0.5-1 inches in thickness. However, the dimensions of device 10 may vary beyond those ranges.

As further shown, device 10 includes at least a keyboard 28 and a display 32. Together, as explained in more detail below in reference to FIG. 2 and FIG. 5, keyboard 28 and display 32 are used to concurrently generate and display control signals for controlling the media device 76.

As also shown in FIG. 1, device 10 is in communication with media device 76 via wireless communications. Device 10 transmits control signals wirelessly to receiver 70. Receiver 70 is connected to media device 76 via USB cable 74 and transmits control signals received from device 10 to media device 76 via USB cable 74.

As indicated by FIG. 1, device 10 pairs with receiver 70 in order to establish a connection via a pairing process. This pairing process is usually done once, but it may be repeated if the connection between the device 10 and the receiver 70 is lost. The pairing process achieves a wireless connection between device 10 and receiver 70 using for example 2.4 GHz wireless protocol. Other wireless protocols may be used, such as Zigbee, infrared.

In general, the pairing process is accomplished by turning on the power on the device 10. Device 10 is confirmed so that the power of device 10 can be turned on by pressing any key of keyboard 28. To indicate that the power of device 10 is turned on, LED lights on device 10, such as status indicator 12, are configured to start to flash, which also indicates that there is no connection yet with receiver 70 although the power of device 10 is on. Next, the device 10 is configured so that certain combinations of keys of keyboard 28 may be engaged (pressed) to complete the pairing process. For example, in a preferred embodiment, keys F10 and J of keyboard 28 are pressed simultaneously for a few seconds to prompt device 10, including transmitter 86 (see FIG. 5), to look for receiver 70 by transmitting signals. The light of status indicator 12 may be configured to start to flash at a certain rate, which indicates that the device 10 has been powered on and is transmitting signals to attempt to pair with receiver 70. The device 10 and display 32 may further be configured so that an explanatory term, such as the word “pairing” will appear on display 32, which also indicates that the device 10 is looking for receiver 70 for purposes of pairing. When device 10 finds receiver 70, that is the transmitted signals of device 10 are received and acknowledged by receiver 70, device 10 and receiver 70 are paired. To visually indicate when this pairing occurs, status indicator 12 may be configured to change from flash to steady light. Other status indicator lights on device 10 may also be configured to convey that pairing (connection) has been established.

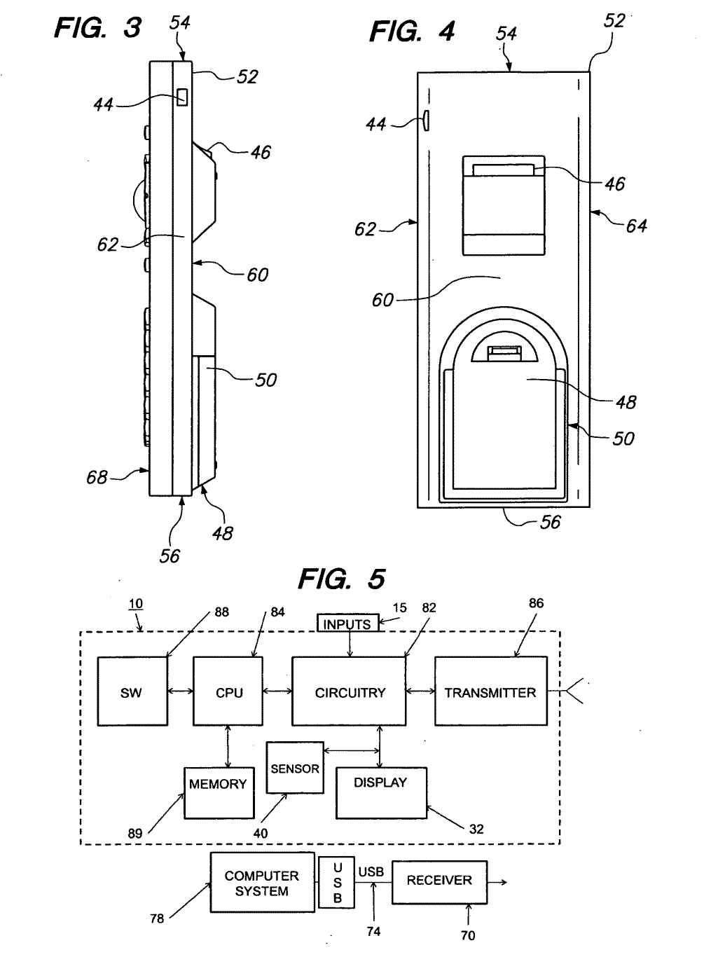

As shown in FIG. 2, device 10 is comprised of a body 52, which includes at least a top 54, bottom 56, front 58, right side 62 and left side 64. As shown further in FIGS. 3 and 4, the body 52 of device 10 also includes a back 60. As shown in FIGS. 3 and 4, back 60 of device 10 includes battery cover 50, and batteries 48 are housed in a battery compartment covered by battery cover 50. Device 10 is preferably made of plastic materials, but any material sufficient to provide a structurally sound frame for a handheld device for light hand and finger use will suffice.

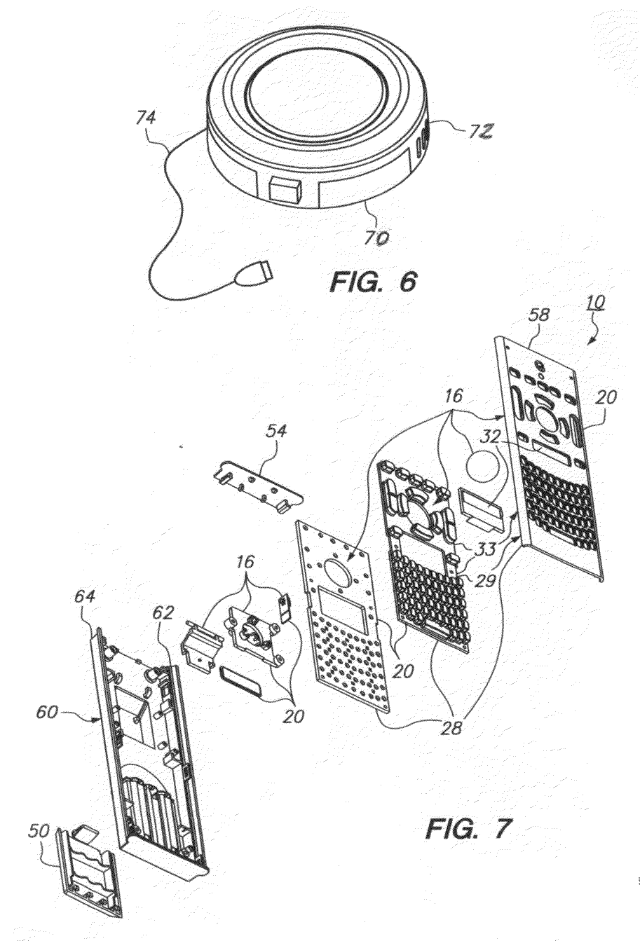

As shown further in FIG. 2, device 10 includes a plurality of control signal input mechanisms 15. As shown, input mechanisms 15 include by example mouse 16, directional pad 20 and keyboard 28. Each input mechanism 15 is individually positioned at a location on the body 52 of device 10. Each input mechanism 15 is electronically connected to the media device 76 (as shown and described for FIG. 1 and FIG. 6). Each input mechanism 15 generates a set of unique control signals for controlling the media device 76.

As also shown in FIG. 2, at least one control signal input mechanism 15 comprises a keyboard 28 mounted on the front 58 of the body 52. Components for such keyboards are commercially available. The body 52 and front 58 of the body 52 of the device 10 are designed to fit the keyboard 28, such as by securely inserting the components into openings in the front 58 of the body 52.

As further shown in FIG. 2, keyboard 28 has keys for engaging (pressing) to generate control signals. In operation, keyboard 28 can be used for any functions typical for keyboard use (e.g., to type search text, URLs and messages).

Keyboard 28 includes various keys for different characters and functions. For example, keyboard 28 includes a shift key, which when pressed concurrently with another key with a secondary character the keyboard 28 provides the secondary character. Keyboard 28 also includes a capital key, which when engaged provides capital characters, and a caps indicator 38 (e.g., an LED indicator light) is provided on body 52 which indicates when caps are enabled/disabled. Keyboard 28 also includes at least one key (e.g., sym key 24) for switching the keyboard 28 between multiple sets of symbols represented by engagement of the keys of the keyboard 28. For example, sym key 24 switches the keyboard 28 from among multiple sets of symbols (e.g., sym key 24 will prompt a file or window, such as from software 88 in FIG. 5, with special characters that are not indicated on the face of the keyboard). That is, sym key 24 opens a menu with special symbols not included in any of the keys on the keyboard 28. Keyboard 28 also includes an enter key 26, for generating enter control signals. As also shown however, device 10 includes at least one additional enter key 30 offset from keyboard 28, for the same purpose but for alternative access.

As shown in FIG. 2, keyboard 28 preferably comprises a QWERTY layout keyboard, although other layouts can be used. A keyboard backlight 29 is also preferably included to selectively illuminate keyboard 28. For example, keyboard backlight 29 will illuminate when any key of the keyboard 28 is pressed, and the keyboard backlight 29 will go off after some seconds of keyboard 28 inactivity. Backlight 33 for the display can be configured in the same way to respond to the pressing of any key of keyboard 28 or to a particular key or set of keys of keyboard 28 to light the backlight 33.

As also shown in FIG. 2, at least one control signal input mechanism 15 further comprises a mouse 16. Mouse 16 is for generating control signals to control movement of a cursor on a display of the media device 76. Mouse 16 has at least two buttons for generating control signals to controlling the cursor on a display of the media device. In particular, as shown in FIGS. 3 and 4, device 10 includes right mouse click button 44 on the right side 62 and left mouse click button 46 on the back side 60.

As also shown in FIG. 2, mouse 16 is mounted on the front 58 of the body 52 like keyboard 28, and mouse 16 is preferably a trackball mouse, as also shown. Components for such mouses are commercially available. The body 52 and front 58 of the body 52 of the device 10 are designed to fit the mouse 16, such as by securely inserting the components into openings in the front 58 of the body 52.

As also shown in FIG. 2, at least one control signal input mechanism 15 comprises a directional pad 20. Directional pad 20 is preferably a directional arrow pad, as shown, having arrows up, down, left and right incorporated within the pad 20. Components for such directional pads are commercially available. The function of directional pad 20 is to provide control signals to provide directional control to the medial device 76. This control is similar to keyboard use of arrows for directional control, (e.g., up/down, right/left) except that the directional pad provides separate and specific control dedicated to directions. More specifically, directional pad 20 is for generating control signals to control the direction of the cursor on the display of the media device 76, the point of view of the display of the media device 76 and the image size of the display of the media device 76.

In the embodiment shown in FIG. 2, directional pad 20 is mounted on the front 58 of the body 52, like the keyboard 28 and mouse 16. The body 52 and front 58 of the body 52 of the device 10 are designed to fit the directional pad 20, such as by securely inserting the components into openings in the front 58 of the body 52.

As also shown in FIG. 2, device 10 also includes a light sensor 40. As shown, light sensor 40 includes a sensor exposed to light via an opening in the front 58 of body 52 of device 10. Light sensor also includes the ability to detect the amount of light exposed to the sensor and to generate a signal corresponding to the amount of light, including whether the light is above or below certain thresholds. Light sensors of this type are commercially available. The purpose of light sensor 40 is to detect a threshold degree of light reaching the sensor and to generate a corresponding control signal for controlling illumination and deillumination of lights, such as the backlight 33 of the display 32 and keyboard backlight 29 of keyboard 28 described above and below. In particular, display 32 and keyboard 28 are backlit by keyboard backlight 29 and display backlight 33 in low lighting conditions when light sensor 40 does not sense a certain threshold of light. As described above in reference to keyboard 28, backlights 29 and 33 can also be configured to illuminate when any key of the keyboard 28 is pressed and go off after some seconds of inactivity of keyboard 28.

As also shown in FIG. 2, a display 32 is mounted on the front side 58 of the body 52 of device 10. Display 32 displays one or more symbols corresponding to control signals in response to the engagement of one or more of the control signal input mechanisms 15. Display 32 is preferably comprised of an LCD display, but can include a variety of display mechanisms such as touch, flat panel and CRT. Display may include a plurality of lines of displays. Display 32 further comprises a backlight 33. And, as explained above and below in reference to FIG. 5, circuitry 82 illuminates the backlight 33 when any key of keyboard 28 is pressed and the light sensor 40 does not detect the threshold degree of light.

The primary purpose of display 32 is to display symbols generated by keyboard 28 and other input mechanisms 15, wherein the symbols represent control signals. For example, keyboard 28 can be used to type search text, URLs and messages, which are considered control signals for purposes of this disclosure. With the device 10, including display 32 and input mechanisms on the device 10, the user can see their inputted control signals on the display 32 of the device 10, rather than having to look to the media device 76 display. This greatly enhances the input process. Users do not have to input symbols (e.g., strings of characters, etc.) and control signals into one device and look to another device to see whether the symbols were correctly entered. Rather, the user can look directly at the display 32 of device 10 while concurrently entering via input mechanisms 15 of device 10. As such, for example, keyboard 28 and display 32 are used to concurrently generate and display control signals for controlling the media device 76.

As shown in FIG. 2, device 10 also includes a home key 14 for generating control signals to select and display the home page of an application program in operation on the media device 76 and for maximizing a displayable image from an application program in operation on the media device 76. In other words, and using multiple game or TV applications running on the media device 76 as examples, engaging the home key 14 can maximize the minimized application. Home key 14 can also be used to display the home page of the application.

As also shown in FIG. 2, device 10 includes escape key 22 to perform an escape function (e.g., executing the well known escape function on a computer or media device running a program). Escape key 22 can be used to go back to the previous menu or to close screens. More specifically, escape key 22, when engaged, is for generating control signals to return to an image previously displayed on the media device 76 and for generating control signals to closing a screen displayed on the media device 76.

As further shown in FIG. 2, device 10 includes next/previous keys 18. Next/previous keys 18 are for generating control signals to change from one image displayed on the media device 76 to a subsequent image to be displayed on the media device 76. Next/previous keys 18 are further for generating control signals for enlarging and reducing the image displayed on the media device 76. These keys allow movement to the next or previous screens in the libraries and to zoom the screen of media device 76 in and out.

Device 10 also includes media control keys 42 as shown in FIG. 2. Media controls 42 are for generating control signals to control the speed and direction of play of images displayed on the media device 76. For example, in Windows Media Player or TV application, media control keys 42 can be used to control the video players (e.g., play, fast forward, reverse, stop, and pause).

In alternative embodiments, the device 10 can include at least one key for switching one or more control signal input mechanisms 15 between functions or modes (e.g., mouse only mode, keyboard only mode, internet TV mode, etc.). For example, function key 36 can be configured to provide this switch between functions or modes. Indicator 12 or other indicators can be configured on device 10 for indicating a mode of a control signal input mechanism 15.

As also shown in FIG. 2, device 10 also includes volume keys 34 to adjust the volume of the media device 76.

As shown in FIG. 5, device 10 includes circuitry 82 electronically connected to the control signal input mechanisms 15 and display 32 for concurrently generating and displaying symbols representing control signals and for changing symbols generated in response to the engagement of one or more keys to the keyboard 28. Circuitry 82 is further electronically connected to CPU 84 for processing, memory 89 for storage and retrieval and software 88 for computing, programming and other software instructions and functions. Software 88 is programmable. Circuitry 82 is inclusive of and/or incorporates CPU 84, memory 89 and software 88 to the extent required for processing control signals, in that circuitry incorporates or is interoperable with each of these items as the electronic connections among the control signal input mechanisms 15. As shown in FIG. 5, and as also discussed in view of FIG. 1 above, device 10 also includes a transmitter 86 for wirelessly communicating with receiver 70 that is in communication with the media device 76. The transmitter 86 provides control signals from the remote device 10 to the media device 76 via the receiver 70.

As shown further in FIG. 5, the device 10 includes a CPU 84 which provides processing of the various control signals processed by the device 10 and provides processing for transmitted control signals by transmitter 86 to receiver 70 and received signals from receiver 70. Device 10 further includes software 88 for computing, instructing and processing (along with CPU 84) the various control signals along generated and processed by the device 10. Device 10 further includes memory 89 for storing control signals and circuitry 82 for retrieving stored control signals from memory 89 via CPU 84 in response to control signals generated by one or more control signal input mechanisms 15. In accord with the controls and functionality of device 10 described above, this memory 89 and circuitry 82 are configured for retrieving stored control signals in response to one or more subsets of control signals generated by one or more control signal input mechanisms 15. For example, circuitry 82 is configured for deilluminating the backlight 33 after a predetermined amount of time in which one or more control signal input mechanisms 15 do not generate control signals, whereby CPU 84 provides processing.

As shown in FIG. 6, the system 11 further includes receiver 70. As explained above in reference to FIG. 1, device 10 transmits control signals wirelessly to receiver 70, which is connected to media device 76 via USB cable 74 and transmits control signals received from device 10 to media device 76 via USB cable 74. Receiver 70 further includes a receiver status indicator 72, which is preferably a LED light or series of LED lights configured to light when the receiver is connected, connecting (pairing), disconnected and on or off. Receiver 70 is preferably comprised of a 2.4 GHz wireless module. USB cable 74 fits USB port for media device 76, which can be any variety of media devices as explained above.

In accord with the description above, the device 10 also provides a method for remotely operating a media device 76. For example, the device 10 can be used in a method to provide control signals to the media device 76. The media device 76 can be selected from among several items, such as a computer system 78, a television system 80 and an Internet television system. At least one control signal input mechanism 15 can be used along with the display to concurrently generate and display symbols representing control signals and to control the media device 76. The device 10 can further be used to review the symbols on the display, and then change one or more symbol to other symbols (e.g., corrections, changes) via one of the control signal input mechanisms 15 as desired to provide the desired control to the media device 76.

FIG. 7 shows an exploded perspective view of the remote control device 10 of the present invention and its components, including components for the assembly of the mouse 16, directional pad 20, display 32, keyboard 28 and displays 33 and 29.

While the particular system and method as herein shown and disclosed in detail is fully capable of obtaining the objects and providing the advantages herein before stated, it is to be understood that they are merely illustrative of the presently preferred embodiments of the invention and that no limitations are intended to the details of construction or design herein shown other than as described in the appended claims.

What is claimed is:

1. A remote control device for controlling a media device which comprises:
a body having a front;
a plurality of control signal input mechanisms, wherein each mechanism is individually positioned at a location on the body, and wherein each mechanism is electronically connected to the media device and generates a set of unique control signals for controlling the media device;
a display mounted on the front side of the body for displaying one or more symbols corresponding to control signals in response to engagement of one or more of the control signal input mechanisms;
circuitry electronically connected to the control signal input mechanisms and display for concurrently generating and displaying symbols representing control signals and for changing symbols generated in response to engagement of one or more of the control signal input mechanisms; and
a transmitter for wirelessly communicating with a receiver that is in communication with the media device, wherein the transmitter provides control signals from the remote device to the media device via the receiver.

2. The device of claim 1 further comprising:
a control signal input mechanism comprising a keyboard mounted on the front of the body, wherein the keyboard has keys for engaging to generate control signals; and
a control signal input mechanism comprising a mouse for generating control signals to control movement of a cursor on a display of the media device and at least two buttons for generating control signals for controlling the cursor on a display of the media device.

3. The device of claim 2 further comprising one control signal input mechanism comprising a directional pad for generating control signals to control the direction of the cursor on the display of the media device, the point of view of the display of the media device and the image size of the display of the media device.

4. A device as recited in claim 2 further comprising a light sensor for detecting a threshold degree of light reaching the sensor, wherein the display further comprises a backlight, and the circuitry illuminates the backlight when the light sensor does not detect the threshold degree of light.

5. A device as recited in claim 2 wherein the keyboard further comprises a QWERTY layout keyboard and at least one key for switching the keyboard between multiple sets of symbols represented by engagement of the keys of the keyboard.

6. A device as recited in claim 2 further comprising a home button for generating control signals to select and display the home page of an application program in operation on the media device and for maximizing a displayable image from an application program in operation on the media device.

7. A device as recited in claim 2 further comprising an escape button for generating control signals to return to an image previously displayed on the media device and for generating control signals to escape and close a screen displayed on the media device and for generating control signals to execute an escape function on the media device.

8. A device as recited in claim 2 further comprising next/previous keys for generating control signals to change from one image displayed on the media device to a subsequent image to be displayed on the media device.

9. A device as recited in claim 8 wherein the next/previous keys are further for generating control signals to enlarge and reduce the image displayed on the media device.

10. A device as recited in claim 2 further comprising media control keys for generating control signals to control the speed and direction of play of images displayed on the media device.

11. A device as recited in claim 3 wherein the directional pad is further for generating control signals to control the point of view of the display of the media device and the image size of the display of the media device.

12. A device as recited in claim 2 further comprising memory for storing control signals and the circuitry for retrieving stored control signals in response to control signals generated by one or more control signal input mechanisms.

13. A device as recited in claim 12 further comprising the memory and the circuitry for retrieving stored control signals in response to one or more subsets of control signals generated by one or more control signal input mechanisms.

14. A device as recited in claim 4 further comprising the circuitry for deilluminating the backlight after a predetermined amount of time in which one or more control signal input mechanisms do not generate control signals.

15. A device recited in claim 2 wherein the media device is comprised from among the group of a computer system, a television system and an internet television system.

16. A system for controlling a media device comprising:
a control device having a body with a front;
a plurality of control signal input mechanisms, wherein each mechanism is individually positioned at a location on the body, and wherein each mechanism is electronically connected to the media device to generate a set of unique control signals for controlling the media device;
a display mounted on the front of the body for displaying one or more symbols, wherein each symbol corresponds to a respective control signal in response to engagement of at least one of the control signal input mechanisms;
circuitry mounted on the control device and electronically connected to each control signal input mechanism, and to the display, for concurrently generating and displaying symbols representing control signals and for changing symbols generated in response to engagement of at least one of the control signal input mechanisms; and
a transmitter for wirelessly communicating with a receiver, wherein the receiver is in communication with the media device, wherein the transmitter provides control signals from the control device to the media device via the receiver, and wherein the media device is in communication with the control device, and further wherein the media device is selected from a group comprising a computer system, a television system and an internet television system.

17. The system of claim 16 wherein the device further comprises:
a control signal input mechanism comprising a keyboard mounted on the front of the body, wherein the keyboard has keys for engaging to generate control signals; and
a control signal input mechanism comprising a mouse for generating control signals to control movement of a cursor on a display of the media device and at least two buttons for generating control signals for controlling the cursor on a display of the media device.

18. A method for remotely controlling a media device comprising the steps of:
providing a control device for generating control signals, wherein the control device has a body and a plurality of control signal input mechanisms, wherein each input mechanism is individually positioned at a respective location on the body;
electronically connecting the control device to the media device;
engaging at least one control signal input mechanism on the control device to generate a unique control signal;
presenting at least one symbol on a display mounted on the control device, wherein the symbol corresponds to a control signal;
transmitting the control signal to a receiver, wherein the receiver is in communication with the media device, for use of the control signal by the media device for controlling the media device; and
selecting the media device from a group comprising a computer system, a television system and an internet television system.

19. The method of claim 18 further comprising the steps of using at least one control signal input mechanism and the display and concurrently generating and displaying symbols representing control signals and controlling the media device.

20. The method of claim 19 further comprising the steps of reviewing symbols representing control signals based on the display of concurrently generated symbols representing control signals and changing at least one of the symbols to another symbol via at least one control signal input mechanism.
